(19) United States
(12) Patent Application Publication
(10) Pub. No.: US 2012/0278294 A1
(43) Pub. Date: Nov. 1, 2012

(54) SELECTIVE LOCKING OF OBJECT DATA ELEMENTS

(75) Inventors: Niranjan K. Iyer, San Diego, CA (US); Matthew J. Insko, Milford, OH (US); Robert Hayden, Dallas, TX (US)

(73) Assignee: SIEMENS PRODUCT LIFECYCLE MANAGEMENT SOFTWARE INC., Plano, TX (US)

(21) Appl. No.: 13/246,940

(22) Filed: Sep. 28, 2011

Related U.S. Application Data
(60) Provisional application No. 61/480,822, filed on Apr. 29, 2011.

(51) Int. Cl. G06F 7/00

(52) U.S. Cl. 707/704; 707/E17.005

(57) ABSTRACT

Product Data Management systems, methods, and mediums. A method includes receiving a lock request for data of a specified type. The method includes processing the lock request in response to the lock request, including locking the data of the specified type for a plurality of data objects in response to the lock request. The method includes receiving at least one change to data of the specified type for at least one of the plurality of data objects, The method includes updating and saving the at least one of the plurality of objects according to the received change by changing the data of the specified type.

### CROSS-REFERENCE TO RELATED APPLICATION

This application claims the benefit of the filing data of U.S. Provisional Patent Application 61/480,822, filed Apr. 29, 2011, which is hereby incorporated by reference.

### TECHNICAL FIELD

The present disclosure is directed, in general, to computer-aided design, visualization, and manufacturing systems (“CAD systems”), product lifecycle management (“PLM”) systems, project and schedule management systems, and systems that manage data for products and other items (individually and collectively, product data management (“PDM”) systems).

### BACKGROUND

PDM systems can aid users in creating and managing project schedules, among other functions, including the scheduling of tasks. PDM systems also maintain schedules, tasks, and other data objects that may occasionally be edited by different processes.

### SUMMARY OF THE DISCLOSURE

Various disclosed embodiments relate to systems and methods for selective data locking and editing with particular utility in schedule management functions, and in particular in PDM systems configured to perform processes as described herein.

Various embodiments include PDM systems, methods, and mediums. A method includes receiving a lock request for data of a specified type. The method includes processing the lock request in response to the lock request, including locking the data of the specified type for a plurality of data objects in response to the lock request. The method includes receiving at least one change to data of the specified type for at least one of the plurality of data objects. The method includes updating and saving the at least one of the plurality of objects according to the received change by changing the data of the specified type.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented in accordance with disclosed embodiments;

FIGS. 2-5 depict flowcharts of processes in accordance with disclosed embodiments; and

FIG. 6 depicts a simplified block diagram of an example of concurrent updating in accordance with disclosed embodiments.

### DETAILED DESCRIPTION

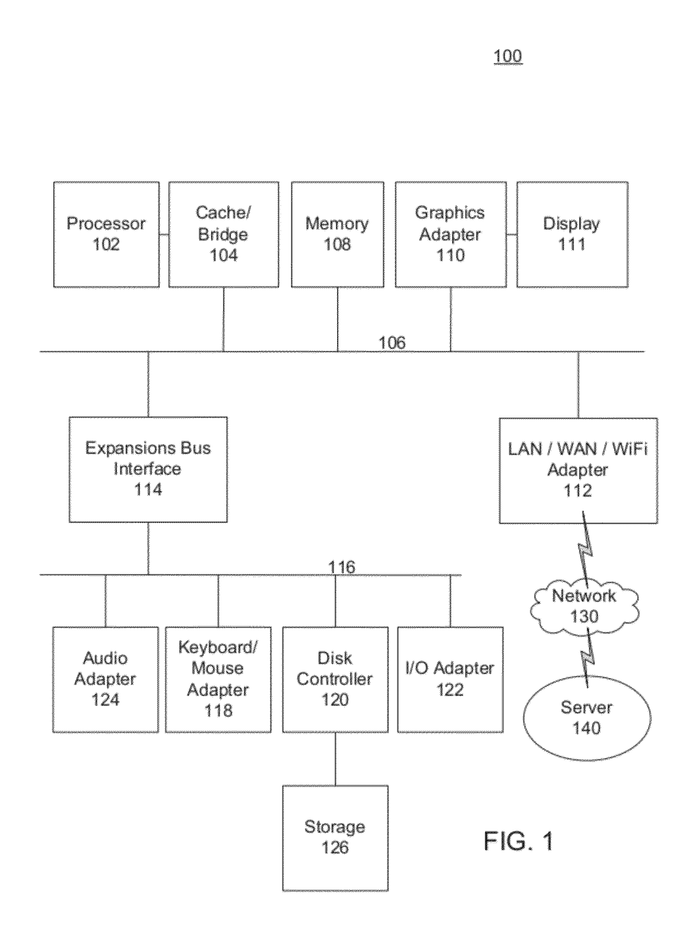

FIGS. 1 through 5, discussed below, and the various embodiments used to describe the principles of the present disclosure in this patent document are by way of illustration only and should not be construed in any way to limit the scope of the disclosure, Those skilled in the art will understand that the principles of the present disclosure may be implemented in any suitably arranged device. The numerous innovative teachings of the present application will be described with reference to exemplary non-limiting embodiments.

Project management systems and other PDM systems have a high level of interdependencies. Tasks are dependent on resource availability and the completion of other tasks. A minor change can cause a “ripple” of changes which cascade across multiple objects in a schedule. In a collaborative system, each of these changes must be persisted to enforce data integrity and allow concurrency, among other reasons. Because of the ripple effect, making multiple minor changes can cause the same fields to change multiple times, causing excessive network and database traffic, The traffic is considered excessive because only the final value is important and any intermediate values are not needed.

if the entire project is locked, the system will not support concurrency. There is not currently a way to lock fields on objects based on certain conceptual or logical boundaries, as opposed to physical boundaries, while allowing concurrent updates to the same object. Disclosed embodiments allow selective and intelligent locking instead of holistic locking.

To preserve data integrity, it is important to lock fields to prevent data corruption. This methodology allows simultaneous access to one type of data and single user access to another type of data and for the reduction of network or database traffic while maintaining data integrity and system concurrency. In a project management system, it may be that only one schedule owner/planner modifies the plan, but potentially hundreds of users would need to update their task status and execution data in parallel.

Disclosed embodiments include improved systems and methods for checking and locking various scheduling functions.

FIG. 1 depicts a block diagram of a data processing system in which an embodiment can be implemented, including as a PDM system particularly configured to perform processes as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. Win) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds, Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Various embodiments include systems and methods for checking and locking functional areas, instead of physical attributes, and utilizing these processes to reduce network and database traffic.

Broadly described, when an application on a PDM system application attempts to update data of type (x) on object (y), the system will request a lock specific for that type and only allow the lock if type (x) is not already locked for that object. For example, this allows concurrent updates to all types which are not (x) on that same object by a different user.

In various embodiments, the objects (y) are tasks in a schedule management system, implemented in a PDM system, and the tasks include information of different types (x). In a scheduling embodiment, the types can include schedule data, task scheduling data, assignments, dependencies, Schedule and Task deliverables, Task costing information, Task Execution Information, schedule membership, notifications, calendars, or otherwise.

By keeping the lock open, intermediate updates are not required to be sent to the server to enforce data integrity. The processes disclosed herein can include a deferred updating of data on a server after the editing is completed and the lock is released.

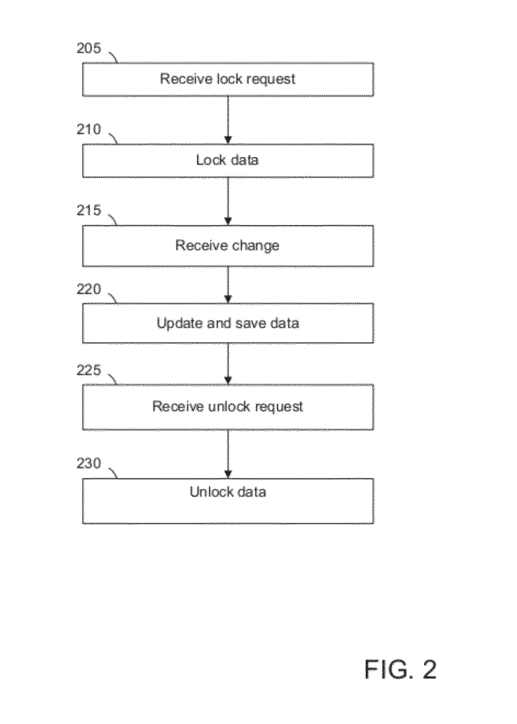

FIG. 2 depicts a flowchart of a process in accordance with disclosed embodiments that can be performed by one or more PDM systems 100, for rapid data editing with selective locking. This process can use the disclosed type-based lock to make large bulk changes on type (x) data.

The system receives a lock request for data of a specified type (step 205). “Receiving”, as used herein, can include loading from storage, receiving from another system or process, receiving via an interaction with a user, and otherwise. This can be an explicit lock request or an implicit lock request, as described herein.

In response to the lock request, the system processes the lock request, which in at least some cases includes locking the data of the specified type for a plurality of data objects (step 210).

The system receives at least one change to data of the specified type for at least one of the plurality of data Objects (step 215). Of course, in some cases, there may be no change, and this step is omitted.

The system updates and saves the data objects according to the received change by changing the data of the specified type (step 220). In some cases, multiple objects are all updated with changes to the data of the specified type; this can include, but is not limited to, making the same updates to multiple objects according to the received change. If there were no changes, the data objects need not be updated and saved, and this step could be omitted.

The system can receive an explicit unlock request for the data of the specified type (step 225).

In response to the unlock request, the system processes the lock request, which in at least some cases includes unlocking the data of the specified type for the plurality of data objects (step 230).

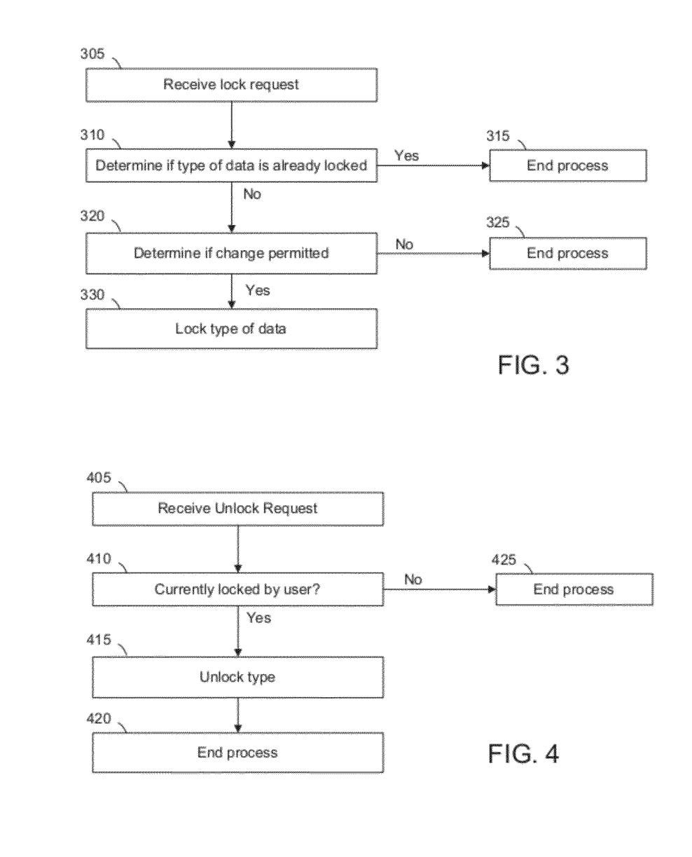

FIG. 3 depicts a flowchart of a process in accordance with disclosed embodiments, that can be performed by one or more PDM systems 100, for processing an explicit lock request.

The system receives an explicit lock request for data of a specified type (step 305). The request can be received from a user. For purposes of this example, the request is to lock a data type (x) in an object (y) and is made by a user (z).

The system determines if the data of the specific type is already locked for that object (step 310). This step can also include determining if the data of the specific type is already locked for that object by the user making the request. In this example, the system determines if data type (x) in object (y) is already locked by user (z).

If it is already locked, the process ends (step 315), since the requested lock already exists. This step can include returning a response that the type is already locked by the user making the request, when that is the case, or can include returning an error when the type is already locked by a different user.

The system determines if a change corresponding to the request is permitted (step 320). This can include determining if the requesting user (z) is permitted to make a change to type (x) in object (y).

If not, the process ends (at step 325). This step can include returning an error, If the change is permitted, the system locks the data type (x) in the object (y) according to the request (step 330). In various embodiments, other data types in the object are not locked.

FIG. 4 depicts a flowchart of a process in accordance with disclosed embodiments, that can be performed by one or more PDM systems 100, for processing an explicit unlock request.

The system receives an explicit unlock request for data of a specified type (step 405). The request can be received from a user. For purposes of this example, the request is to unlock a data type (x) in an object (y) and is made by a user (z).

The system determines if the data of the specific type is currently locked for that object (step 410). This step can also include determining if the data of the specific type is already locked for that object by the user making the request. In this example, the system determines if data type (x) in object (y) is already locked by user (z). This can be performed at once for all objects (y).

If it is already locked by that user, the system unlocks the type in the object (step 415). The process then ends (step 420). This can be performed at once for all objects (y).

If the data of the specific type is not already locked for that object by the user making the request, the process ends (step 425). This step can include returning an error that the user is not permitted to unlock that type for that object.

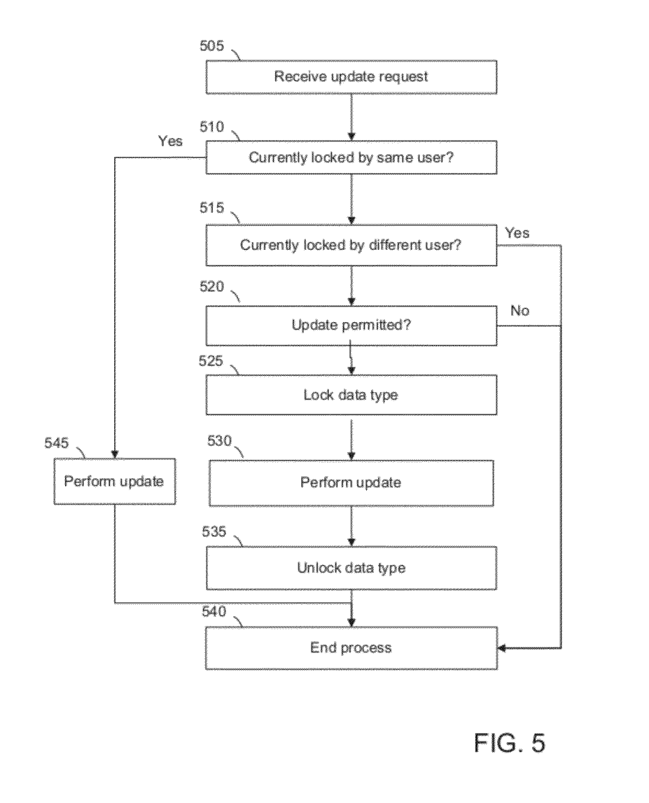

FIG. 5 depicts a flowchart of a process in accordance with disclosed embodiments, that can be performed by one or more PDM systems 100 for processing an implicit lock request.

The system receives a request to update data of a specified type for an object (step 505). The request can be received from a user. For purposes of this example, the request is to update data of type (x) in an object (y) and is made by a user (z).

The system determines if the data of the specific type is already locked for that object (step 510). This step can also include determining if the data of the specific type is already locked for that object by the user making the request. In this example, the system determines if data type (x) in object (y) is already locked by user (z). This can be performed at once for all objects (y).

If it is already locked for that user, the system processes the requested update (step 545) and the process ends (step 540). This can be performed at once for all objects (y). Note that if the data type was already locked for that user, then it is not automatically unlocked after the update. In such cases, the processes described at steps 515-535 can be skipped or omitted.

The system determines if the type and that object is currently locked by a different user (step 515). If so, the process ends (step 540). This step can include returning an error or other response to the user.

The system determines if the requested update is permitted (step 520), This can include determining if the requesting user (z) is permitted to make a change to type (x) in object (y).

If not, the process ends (at step 540). This step can include returning an error.

If the change is permitted, the system locks the data type (x) in the object (y) according to the request (step 525). The system processes the requested update (step 530). Steps 530 and 545 can be performed in the same way, and are separated here for clarity.

The system can then unlock that data type (x) in the object (y) (step 535), and the process ends (step 540). This can be performed at once for all objects (y).

In various embodiments, when a lock is applied on data of a specified type, then only those parts are locked to the user and disallowed for other users while the other data types in the plurality of objects are still allowed to be updated. That is, data of a different type for the plurality of objects can be updated by other processes or users while the data of the specified type is locked.

The various processes used herein can be used on a single system for rapidly updating various data, and can be used by multiple PDM systems together, in particular to allow multiple systems and their users to simultaneously update any data type that is not currently locked.

In many applications, different types of updates affect different parts of persisted objects. The processes described herein allows for the maintenance of data integrity while allowing concurrent updates to different areas of the object based on logical instead of physical boundaries.

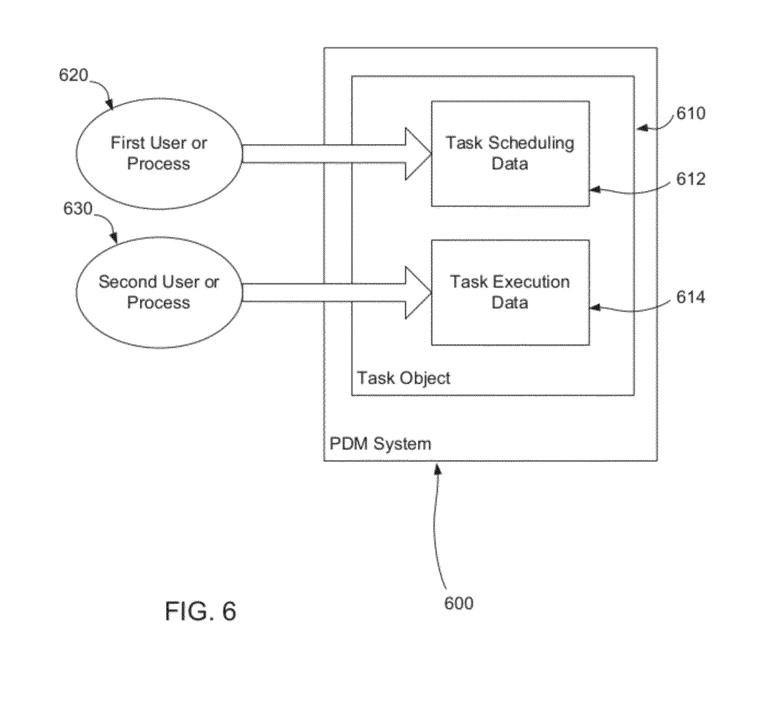

FIG. 6 depicts a simplified block diagram of an example of concurrent updating using techniques as disclosed herein, in an exemplary scheduling context.

In this figure, a PDM system 600 maintains and stores a task object 610. Task object 610 includes two types of data, task scheduling data 612 and task execution data 614. Task scheduling and execution data are non-limiting examples, and the processes described herein also apply to other types of data.

A first process or user 620, such as the coordinator of a schedule, can request a lock on specific data types, such as task scheduling data 612 on the task object 610. That allows the first user 620 to get exclusive rights to the task scheduling data 612,

At the same time, a second user or process 630, such as an assigned user with lower permissions, is allowed to update task execution data 614 on the same task object 610, since only the task scheduling data 612 is locked by the first user 620. Note that first user 620 and second user 630 can each be on the same or different systems than PDM system 600, and can each be local or remote from PDM system 600.

As used herein, an “Object” refers to data object being checked. This can be a representation of a physical object or a collective group of objects or otherwise, “Type” refers to the type of updates being made. A single object can have multiple independent types of updates. “Holistic Locking” refers to a lock applied to the entire object (or collection of objects).

Unless otherwise described, the various processes, actions, and steps described. above can be performed concurrently, sequentially, in a different order, or omitted in various embodiments.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims, Moreover, none of these claims are intended to invoke paragraph six of 35 USC §112 unless the exact words “means for” are followed by a particle.

What is clamed is:

1. A method performed by a product data management (PDM) data processing system, comprising:
receiving a lock request for data of a specified type;
processing the lock request in response to the lock request, including locking the data of the specified type for a plurality of data objects in response to the lock request;
receiving at least one change to data of the specified type for at least one of the plurality of data objects; and
updating and saving the at least one of the plurality of objects according to the received change by changing the data of the specified type.

2. The method of claim I, wherein processing the lock request includes determining if the data of the specific type is already locked for the at least one of the plurality of data objects.

3. The method of claim 1, wherein processing the lock request includes determining if a change corresponding to the request is permitted.

4. The method of claim 1, wherein the PDM data processing system also receives an explicit unlock request for the data of the specified type and in response to the unlock request, processes the unlock request including unlocking the data of the specified type for a plurality of data objects.

5. The method of claim 4, wherein the unlock request corresponds to a user, and processing the unlock request includes determining if the data of the specific type is currently locked for the object and the user.

6. The method of claim 1, wherein a plurality of the objects are each updated according to the change to the data of the specified type.

7. The method of claim 1, wherein data of a different type for the plurality of objects can be updated by other processes while the data of the specified type is locked.

8. A product data management (PDM) data processing system, comprising:
at least one processor; and
an accessible memory, wherein the PDM data processing system is configured to:
receive a lock request for data of a specified type;
process the lock request in response to the lock request, including locking the data of the specified type for a plurality of data objects in response to the lock request;
receive at least one change to data of the specified type for at least one of the plurality of data objects; and
update and saving the at least one of the plurality of objects according to the received change by changing the data of the specified type.

9. The PDM data processing system of claim 8, wherein processing the lock request includes determining if the data of the specific type is already locked for the at least one of the plurality of data objects.

10. The PDM data processing system of claim 8, wherein processing the lock request includes determining if a change corresponding to the request is permitted.

11. The PDM data processing system of claim 8, wherein the PDM data processing system also receives an explicit unlock request for the data of the specified type and in response to the unlock request, processes the unlock request including unlocking the data of the specified type for a plurality of data objects.

12. The PDM data processing system of claim 11, wherein the unlock request corresponds to a user, and processing the unlock request includes determining if the data of the specific type is currently locked for the object and the user.

13. The PDM data processing system of claim 8, wherein a plurality of the objects are each updated according to the change to the data of the specified type.

14. The PDM data processing system of claim 8, wherein data of a different type for the plurality of objects can be updated by other processes while the data of the specified type is locked.

15. A non-transitory computer-readable medium encoded with executable instructions that, when executed, cause a product data management (PDM) data processing system to:
receive a lock request for data of a specified type;
process the lock request in response to the lock request, including locking the data of the specified type for a plurality of data objects in response to the lock request;
receive at least one change to data of the specified type for at least one of the plurality of data objects; and
update and saving the at least one of the plurality of objects according to the received change by changing the data of the specified type.

16. The computer-readable medium of claim 15, wherein processing the lock request includes determining if the data of the specific type is already locked for the at least one of the plurality of data objects.

17. The computer-readable medium of claim 15, wherein processing the lock request includes determining if a change corresponding to the request is permitted.

18. The computer-readable medium of claim 15, wherein the PDM data processing system also receives an explicit unlock request for the data of the specified type and in response to the unlock request, processes the unlock request including unlocks the data of the specified type for a plurality of data objects.

19. The computer-readable medium of claim 18, wherein the unlock request corresponds to a user, and processing the unlock request includes determining if the data of the specific type is currently locked for the object and the user.

20. The computer-readable medium of claim 15, wherein a plurality of the objects are each updated according to the change to the data of the specified type.

21. The computer-readable medium of claim 15, wherein data of a different type for the plurality of objects can be updated by other processes while the data of the specified type is locked.
